(19) United States
(12) Patent Application Publication
(10) Pub. No.: US 2021/0315366 A1
(43) Pub. Date: Oct. 14, 2021

(54) GUIDE RAIL ACCESSORY FOR A PORTABLE ELECTRONIC DEVICE

(71) Applicant: PopSockets LLC, Boulder, CO (US)

(72) Inventors: Edward Licitra, Boulder, CO (US); Nicholas Ross, Boulder, CO (US); Isamu Taguchi, Boulder, CO (US); Robert Lane, Boulder, CO (US)

(21) Appl. No.: 17/137,894

(22) PCT Filed: Jun. 20, 2019
(86) PCT No.: PCT/US2019/038261

§ 371 Date: Dec. 30, 2020

Related U.S. Application Data
(60) Provisional application No. 62/694,648, filed on Jul. 6, 2018.

(51) Int. Cl. A45F 5/00; A45C 11/00; H04B 1/3877

(52) U.S. Cl. CPC A45F 5/00; A45C 11/00; H04B 1/3877; F16M 13/005; A45C 2011/001; A45F 2200/0516; A45F 2200/0508; A45C 2011/002

(57) ABSTRACT

An accessory for an electronic device or case for an electronic device that includes a walled loop defining a first end, a second end, and an opening extending between the first end and the second end. The walled loop is arranged to attach to a surface of an electronic device or case. An expandable grip accessory is disposed in the opening and movable in the opening of the walled loop between the first end and the second end of the walled loop. The expandable grip accessory has a first end coupled to the walled loop and a second end opposite the first end. The walled loop at least partially surrounds the first end of the expandable grip accessory.

### CROSS-REFERENCE TO RELATED APPLICATION

The present application claims priority to U.S. Provisional Patent Application No. 62/694,648, filed Jul. 6, 2018, the entire contents of which are hereby incorporated by reference.

### FIELD OF DISCLOSURE

The present disclosure relates generally to an accessory for a portable electronic device or case for a portable electronic device, and in particular, an guide rail accessory for attaching an expandable grip accessory to an electronic device or case for an electronic device.

### BACKGROUND

Portable electronic devices, such as MP3 players and smart phones, are often housed in protective covers or cases in order to protect the device from damage, provide a grip for handling the device, and/or provide a stand for propping the device on a surface. Such cases increase the effective size of the device. Expandable devices, which may be attached directly to the device or to the case protecting the device, are used for a variety of functions, including propping the device on a surface and providing an expandable grip for handling the device. The expandable devices have decorative buttons, which may display logos, decals, symbols, or other artistic renderings.

### SUMMARY

In accordance with a first exemplary aspect, a guide rail accessory for a portable electronic device or a case for a portable electronic device is disclosed herein. The accessory may include a walled loop defining a first end, a second end, and an opening extending between the first end and the second end. The walled loop may be arranged to attach to a surface of an electronic device or case. An expandable grip accessory may be movably disposed in the opening of the walled loop between the first end and the second end of the walled loop. The expandable grip accessory may have a first end coupled to the walled loop and a second end opposite the first end. The walled loop may be adapted to at least partially surround the first end of the expandable grip accessory to retain the expandable grip accessory.

In accordance with a second exemplary aspect, a case for a portable electronic device may include a case body arranged to receive a portable electronic device on a first face and may include a second face opposite the first face. The case may include a walled loop carried by the second face of the case body. The walled loop may include a first end, a second end, and an opening extending between the first end and the second end. The walled loop may be adapted to retain a mobile grip accessory for movement between various positions along the opening of the walled loop.

In further accordance with any one or more of the foregoing first and second aspects, an accessory and/or a protective case may further include any one or more of the following preferred forms.

In a preferred form, the expandable grip accessory may be movable along a lateral axis and may be movable along a longitudinal axis.

In a preferred form, the expandable grip accessory may be slidably coupled to the track and may be movable in a lateral direction.

In a preferred form, the expandable grip accessory may be movable along a longitudinal axis between an expanded configuration and a collapsed configuration.

In a preferred form, a track may include the walled loop and a flange extending from the walled loop.

In a preferred form, the track may slidably receive the expandable grip accessory.

In a preferred form, the flange may extend around the walled loop and may be adapted to limit movement of the expandable grip accessory along the longitudinal axis.

In a preferred form, a platform may be coupled at the first end of the expandable grip accessory, and the walled loop may be arranged to slidably receive the platform.

In a preferred form, the expandable grip accessory may include a button removably attached to the second end, and the button may have a diameter wider than a width of the opening of the walled loop.

In a preferred form, the first end of the walled loop may include a locking member adapted to releasably lock to the expandable grip accessory. The locking member may be adapted to retain the expandable grip accessory in a position adjacent the first end when the locking member engages the expandable grip accessory.

In a preferred form, an expandable grip accessory may be adjacent to the second face of the case body. The expandable grip accessory may include a device body having a first end and a second end. The walled loop may be arranged to surround the first end of the device body when the expandable grip accessory is coupled to the walled loop. The expandable grip accessory may be slidable through the opening of the walled loop from a first position to a second position.

In a preferred form, the platform may be disposed between the second face of case body and a flange of the walled loop.

In a preferred form, the flange may extend around the walled loop and may limit movement of the expandable grip accessory along a longitudinal axis of the expandable grip accessory.

In a preferred form, the first end of the walled loop may include a locking member adapted to releasably lock to the expandable grip accessory. The locking member may be adapted to retain the expandable grip accessory in a position adjacent the first end of the walled loop when the locking member engages the expandable grip accessory.

In a preferred form, the walled loop may be integrally formed with the second face of the case body.

In a preferred form, the walled loop may be fixed to the second face of the case body.

In a preferred form, the walled loop may be removably coupled to the second face of the case body.

In a preferred form, a track may include the walled loop and a flange protruding into the opening from the walled loop.

In a preferred form, the track may have a linear shape.

In a preferred form, the track may be cross-like shape.

In a preferred form, the track may include a horizontal portion and a diagonal portion.

### BRIEF DESCRIPTION OF THE DRAWINGS

FIG. 1 is a top view of an expandable grip accessory, an electronic device, and a first exemplary guide rail constructed in accordance to the teachings of the present disclosure, and showing the expandable grip accessory in a first position;

FIG. 2 is a perspective view of the expandable grip accessory, the electronic device, and the guide rail of FIG. 1;

FIG. 3 is a perspective view of the expandable grip accessory, the electronic device, and the guide rail of FIG. 1, and shows the expandable grip accessory in a second position and in a partially expanded configuration;

FIG. 4 is a perspective view of the expandable grip accessory, the electronic device, and the guide rail of FIG. 1, and shows the expandable grip accessory in the second position and in a fully expanded configuration;

FIG. 5 is a top view of an electronic device and a second exemplary guide rail for an expandable grip accessory constructed in accordance to the teachings of the present disclosure;

FIG. 6 is a top view of an electronic device and a third exemplary guide rail for an expandable grip accessory constructed in accordance to the teachings of the present disclosure; and

FIG. 7 is a top view of a case for an electronic device and a fourth exemplary guide rail for an expandable grip accessory constructed in accordance to the teachings of the present disclosure.

### DETAILED DESCRIPTION

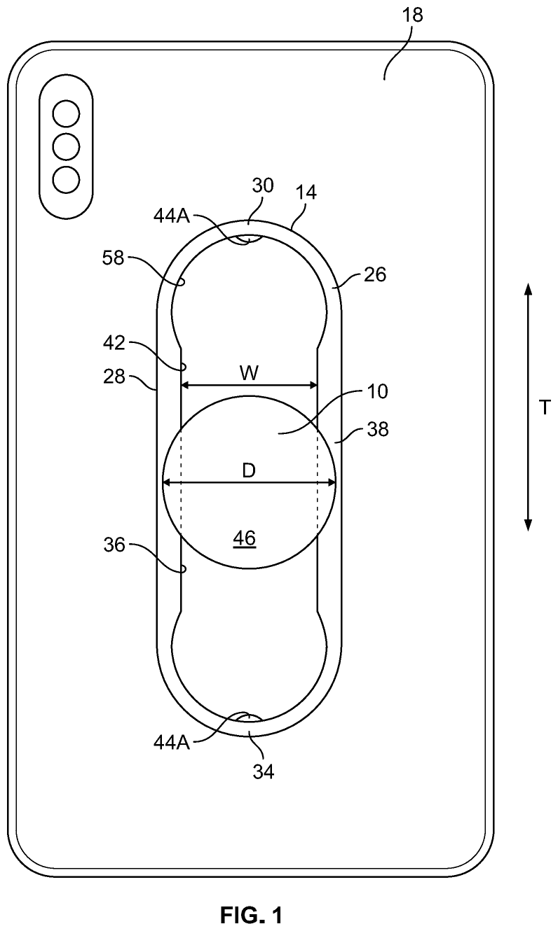

FIG. 1 illustrates a first exemplary expandable grip accessory 10 and guide rail 14 constructed in accordance with the teachings of the present disclosure. The guide rail 14 is attached to an electronic device 18 or case for the electronic device 18 and is arranged to permit a user to move the expandable grip accessory 10 between at least two positions across an exterior surface 22 of the electronic device 18 or case. In the illustrated example, the guide rail 14 is directly attached to the outer surface 22 of the electronic device 18. The guide rail 14 may be a pliable material that may flex to conform to an uneven exterior or other mounting surface of an electronic device 18 or case.

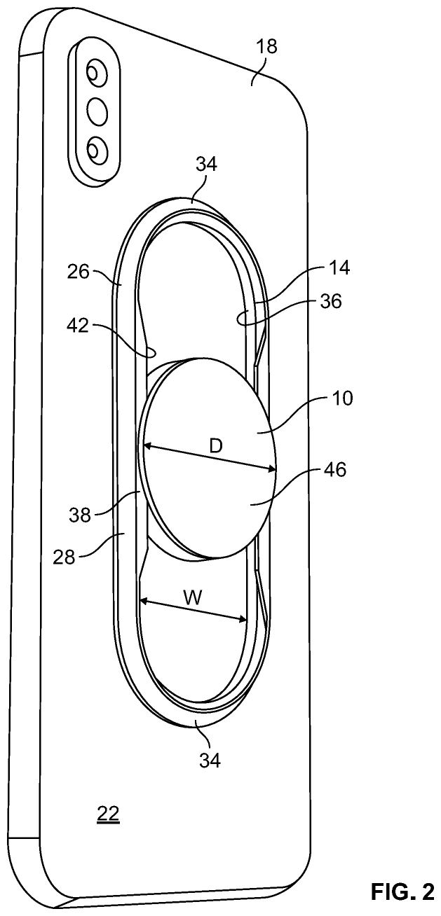

The first exemplary guide rail 14 illustrated in FIGS. 1-4 includes a track 26 extending between a first end 30 and a second end 34. The expandable grip accessory 10 is slidably coupled to the guide rail 14 and is arranged to snap or lock into different docking positions between, and adjacent to, the first and second ends 30, 34 of the track 26. The track 26 includes an oval-shaped walled loop 28, which surrounds the expandable grip accessory 10 and defines an opening 36 in which the expandable grip accessory 10 moves. In FIG. 1, the expandable grip accessory 10 is disposed at a middle position 38 of the track 26 between the first end 30 and the second end 34. The track 26 also includes an inner rail 42 or flange extending inwardly into the opening 36 of the walled loop 28. The inner rail 42 engages the expandable grip accessory 10 to prevent the expandable grip accessory 10 from sliding out of engagement with the guide rail 14, and, in places, to retain the expandable grip accessory 10 in docking positions between the first and second ends 30, 34. While the guide rail 14 permits sliding of the expandable grip accessory 10, the interior rail 42 may protrude from the walled loop 28 at particular areas of the track 26 to retain the expandable grip accessory 10 in those areas. The expandable grip accessory 10 remains in a docking position (e.g., the middle position 38 of FIGS. 1 and 2) until a user engages (e.g., pushes, pulls, forces, drives, etc.) the expandable grip accessory 10 to move along the track 26 in a direction T. For example, the inner rail 42 engages the expandable grip accessory 10 in certain areas within the track 26 of the guide rail 14. In another example, the expandable grip accessory 10 may slide freely when disposed in the middle position 38 such that the expandable grip accessory 10 may rest at either the first end 30 or the second end 34 of the track 26.

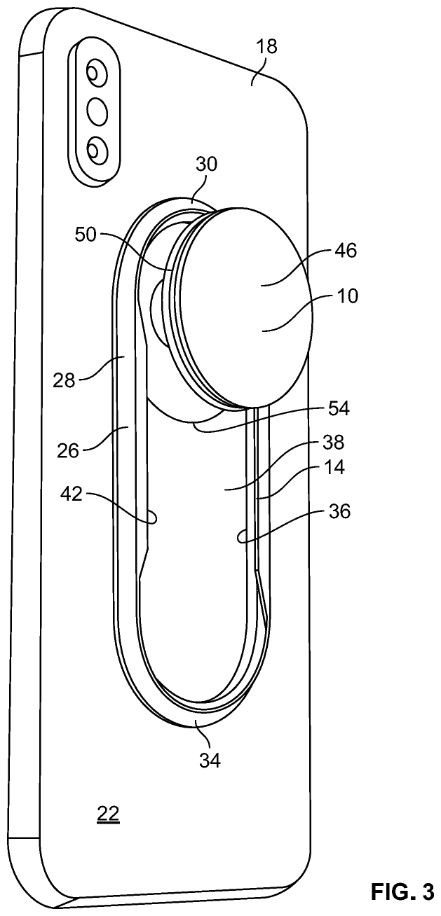

In the illustrated example of FIGS. 1-4, the expandable grip accessory 10 engages with the inner rail 42 of the track 26 to remain coupled to the rail 14 and n a particular position between the first and second ends 30, 34 of the track 26. For example, when the electronic device 18 is in an upright position as shown in FIG. 2, the expandable grip accessory 10 engages with the inner rail 42 at the middle 38 of the track 26, remains in the middle docking position, and does not slide relative to the track 26 due to the force of gravity. As shown in FIG. 3, the expandable grip accessory 10 is disposed at the first end 30 and engages with the rail 14 to remain at the docking position adjacent the first end 30. Additionally, the expandable grip accessory 10 may snap into or releasably lock to the track 26 when the expandable grip accessory 10 is in a docking position. For example, at each of the first end 30 or the second end 34, a locking member 44A, 44B extends from the walled loop 28 and into the opening 36 of the track 26 to engage with a portion of the expandable grip accessory 10. When the expandable grip accessory 10 is in a docking position adjacent to the first end 30 or the second end 34 of the track 26, the locking member 44A, 44B engages the expandable grip accessory 10 to lock the expandable grip accessory 10 into the docking position. The expandable grip accessory 10 may have a receiving notch or may elastically deform to engage the locking member 44A, 44B at each docking position. In other examples, the expandable grip accessory 10 engages the locking member track 26 by snap-fit, friction-fit, female/male engagement, or other locking mechanism.

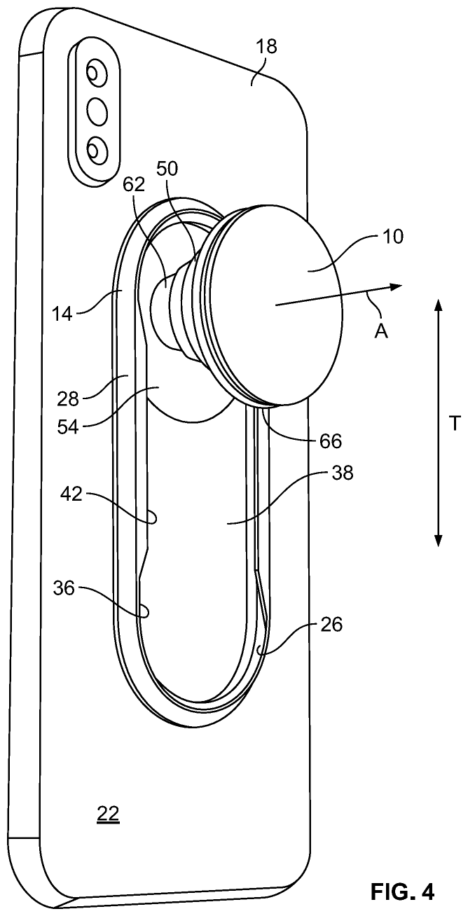

Generally speaking, a user of the expandable grip accessory 10 and guide rail 14 may move the expandable grip accessory 10 in both a longitudinal direction A direction (to expand or collapse the grip accessory 10), as well as a lateral direction T (to slide the device 10 between the first and second ends 30, 34 of the track 26). The expandable grip accessory 10 may also rotate about its central axis while coupled to the track 26. As shown in FIG. 4, the expandable grip accessory 10 includes a button 46, a body 50 attached to the button 46, and a platform 54 that is adjacent to the outer surface 22 of the portable electronic device 18 or case. To move the expandable grip accessory 10 from the collapsed configuration (FIGS. 1 and 2), the user may grab or grasp the button 46 and pull upward and away from the platform 54 in the longitudinal direction A until the expandable grip accessory 10 is in a fully expanded configuration, and as shown in FIG. 4. To collapse the expandable grip accessory 10, the user can push the button 46 downward toward the platform 54 until the body 50 is fully collapsed.

The user may also grab or grasp the button 46 and/or body 50 of the expandable grip accessory 10 to move the grip accessory 10 in the lateral T direction. Initially, if the expandable grip accessory 10 is locked in a docking position, a user may unlock the device 10 from the docking position by grabbing or grasping the button 46 or body 50 and moving (e.g., rotating, twisting, sliding) the button 46 or body 50 out of engagement with the locking mechanism and/or inner rail 42 of the guide rail 14. The user may then move (e.g., push, pull, force, drive, slide) the expandable grip accessory 10 toward another docking position along the track 26 until the expandable grip accessory 10 engages the inner rail 42 and/or locking member 44A, 44B and lock into the docking position.

The body 50 of the expandable grip accessory 10 can include an accordion-like structure having a collapsible wall. The body 50 includes a first end 62 and a second end 66, in which the first end 62 is coupled to the platform 54 and the second end 66 is coupled to the button 46. The button 46 may serve as a gripping surface in which a user may contact (e.g., push, pull, force) to move the expandable grip accessory 10 within the track 26. The body 50 can be made of a flexible material, such as polyester-based thermoplastic polyurethane elastomer, that may be formed by injection molding, thermoforming, or compression molding, or may be any equivalently functional material suitable for its intended purpose. In some instances, the expandable grip accessory 10 of the current disclosure may be in the form of a commercially available grip and stand product such as that available on www.popsockets.com. For example, U.S. Pat. No. 8,560,031, filed on Feb. 23, 2012; U.S. Pat. No. 9,970,589, filed on Nov. 9, 2017; U.S. application Ser. No. 15/615,900, filed on Jun. 7, 2017; U.S. application Ser. No. 15/679,934, filed on Aug. 17, 2017; U.S. application Ser. No. 15/803,410, filed on Nov. 3, 2017; U.S. application Ser. No. 15/808,076, filed on Nov. 9, 2017; U.S. application Ser. No. 15/864,402, filed on Jan. 8, 2018; U.S. application Ser. No. 15/864,509, filed on Jan. 8, 2018; U.S. application Ser. No. 15/906,920, filed on Feb. 27, 2018; U.S. application Ser. No. 15/922,601, filed on Mar. 15, 2018; U.S. application Ser. No. 15/952,025, filed on Apr. 12, 2018; U.S. application Ser. No. 15/993,458, filed on May 30, 2018; and U.S. application Ser. No. 16/001,723, filed on Jun. 6, 2018 each describe suitable expandable grip and stand product, which also incorporate collapsible mechanisms, the entirety of each being hereby incorporated by reference.

The expandable grip accessory 10 may be attached to the guide rail 12 by disposing the platform 48 into the opening 58 defined by the inner rail 42. The platform 54 may be angled relative to the surface 22 of the electronic device 18 or case so that the platform 54 can slide beneath the protruding flange of the inner rail 42 and against the exterior surface 22 of the electronic device 18 or case. When the expandable grip accessory 10 is coupled to the rail 14, the button 46 is disposed above the protruding flange of the inner rail 42. The button 46 has a diameter D that is wider than a width W of the opening 36 of the track 26, and, similarly, a diameter of the platform 54 is wider than the width W of the opening 36, to prevent the expandable grip accessory 10 from falling through the opening 36 after the device 10 has been coupled to the guide rail 14. Thus, when the device 10 is coupled to the guide rail 14, the platform is disposed in the track between the protruding flange of the inner rail 42 and the electronic device 18 or case. In the illustrated example, a bottom surface of the platform 54 slides against the outer surface 22 of the portable electronic device 18 or case when the device 10 moves within the track 26. However, in another example, the guide rail 14 may have an additional layer disposed between the outer surface 22 of the electronic device 18 or case and the protruding flange 42. In this case, when the expandable grip accessory 10 is coupled to the guide rail 14, the platform 54 slides against the surface of the base rather than the exterior surface 22 of the electronic device 18 or case.

Alternatively, the expandable grip accessory 10 may be coupled to the guide rail 14 prior to attaching the guide rail 14 to an electronic device 18 or case. For example, the second end 66 of the expandable grip accessory 10 may be pliable and/or sized to slide or push through the opening 36 of the track 26 from beneath the protruding flange of the inner rail 42. Once the second end 66 is disposed above the protruding flange of the inner rail 42, the button 46 and the platform 54 keep the expandable grip accessory 10 from falling through the opening 36 of the track 26. The second end 66 may be inserted through the opening 36 with or without the removable button 46 attached. After the expandable grip accessory 10 is coupled to the track 26, the guide rail 14 (with expandable grip accessory 10 attached) may be attached to the electronic device 18 or case for the electronic device 18.

The removable button 46 may have artistic value (e.g., an artistic rendering, a logo, a symbol, text, or a decal) and may provide a grip that allows a person to slide the folded portion of the body 50 between two fingers such that the platform 54 is disposed within the fingers or palm of the person's hand, and the button 56 is disposed adjacent the back of the person's hand. The configuration of the button 46 and the body 50 may also provide a space in which a cord, such as a cord for earphones, may be wrapped and stored around a portion of the body 50. Thus, it may be desirable to remove the button 46 and replace it with another button 46 that features a different aesthetic design, provides a different grip so as to change the look and/or function of the button 46.

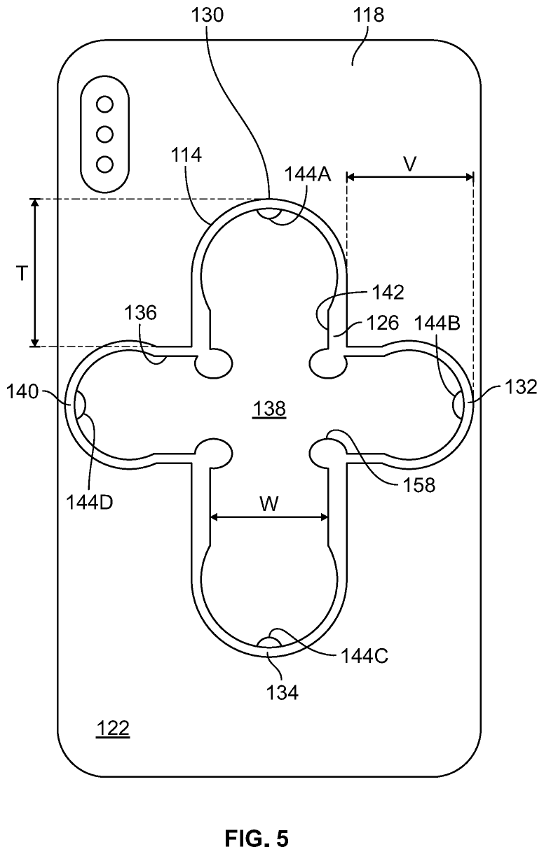

FIG. 5 illustrates a second exemplary guide rail 114 for an electronic device 118 or case for an electronic device 118 constructed in accordance with the teachings of the present disclosure. The second exemplary guide rail 114 is similar to the first exemplary guide rail 14 described above, thus for ease of reference and to the extent possible, the same or similar components of the second exemplary guide rail 114 in FIG. 5 will retain the same reference numbers as outlined above with respect to the first exemplary guide rail 14, although the reference numbers will be increased by 100. A description of many of these elements is abbreviated or even eliminated in the interest of brevity.

The guide rail 114 of FIG. 5 provides a cross-shaped track 126 having a docking position adjacent to each one of a first end 130, a second end 132, a third end 134, and fourth end 140 of a walled loop 126. Similar to the track 26 of the first exemplary guide rail 14, the track 126 of the second exemplary guide rail 114 in FIG. 5 has an inner rail 142 with a protruding flange that defines an inner perimeter or opening 136 of the track 126 in which an expandable grip accessory may move. The protruding flange of the inner rail 142 is shaped to define various narrow paths in which the expandable grip accessory can travel, and without falling (i.e., decoupling), through the opening 136 of the guide rail 114. When coupled to the cross-shaped track 126, an expandable grip accessory may slide from a first docking position adjacent the first end 130 to another docking position in a middle 138 of the track 126 or adjacent to the second, third, or fourth ends 132, 134, and 140. To move the expandable grip accessory from one docking position to another, a user may move the expandable grip accessory in either a first lateral direction T or a second lateral direction Vout of one of the docking positions, into the middle 138, and then further into a docking position until the expandable grip accessory snaps or locks into place. The protruding flange 142 of the track 126 may be shaped such that the expandable grip accessory snaps into the middle docking position 138 before sliding into another docking position. As shown in FIG. 5, the inner rail 142 has circular protruding tabs adjacent to the middle 138 of the track 126. The protruding tabs are configured to engage a platform of an expandable grip accessory to keep the expandable grip accessory from decoupling from the track 126.

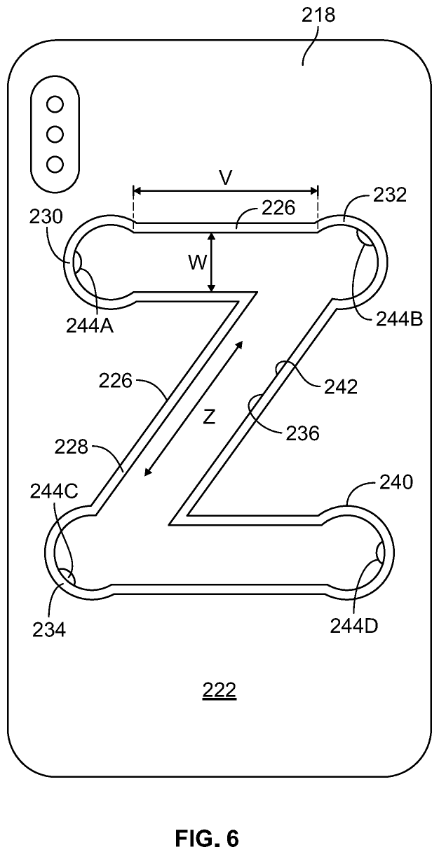

FIG. 6 illustrates a third exemplary guide rail 214 for an electronic device 210 or case for an electronic device 210 constructed in accordance with the teachings of the present disclosure. The third exemplary guide rail 214 is similar to the first exemplary guide rail 14 described above, thus for ease of reference and to the extent possible, the same or similar components of the third exemplary guide rail 214 in FIG. 6 will retain the same reference numbers as outlined above with respect to the first exemplary guide rail 14, although the reference numbers will be increased by 200. A description of many of these elements is abbreviated or even eliminated in the interest of brevity. The guide rail 214 of FIG. 6 provides a Z-shaped track 126, and like the second exemplary guide rail 114, the third exemplary guide rail 214 provides a docking position adjacent to first, second, third, and fourth ends 230, 232, 234, 240 of a walled loop 228. The track 226 is shaped to permit an expandable grip accessory to move in a first lateral V direction from the docking position adjacent to the first end 230 to the docking position adjacent to the second end 232, in a second lateral Z direction from the docking position adjacent the second end 232 to the docking position adjacent the third end 234, and again in the first lateral V direction from the docking position adjacent the third end 234 to the docking position adjacent the fourth end 240.

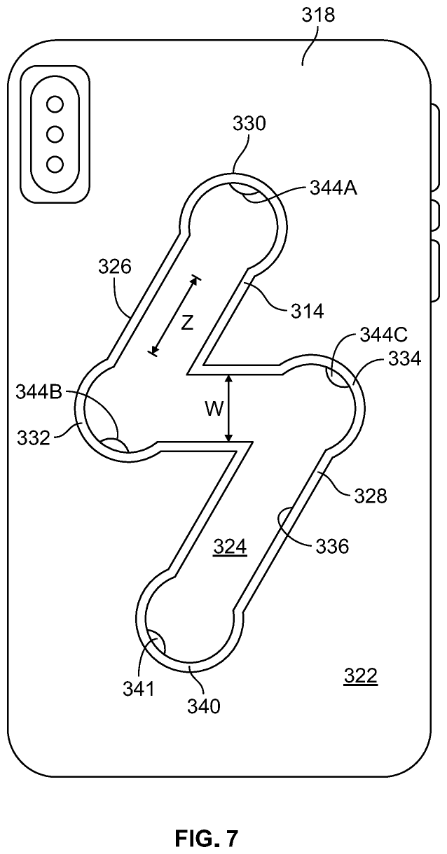

FIG. 7 illustrates a fourth exemplary guide rail 314 constructed in accordance with the teachings of the present disclosure, which is integrally formed with, or attached to, a case 310 for an electronic device. The fourth exemplary guide rail 314 is similar to the first exemplary guide rail 14 described above, thus for ease of reference and to the extent possible, the same or similar components of the fourth exemplary guide rail 314 in FIG. 7 will retain the same reference numbers as outlined above with respect to the first exemplary guide rail 14, although the reference numbers will be increased by 300. A description of many of these elements is abbreviated or even eliminated in the interest of brevity.

In this example, the guide rail 314 is adjacent to a mounting surface 322 of a case body 318 of a protective case or cover for an electronic device. The guide rail 314 may be attached to the mounting surface 322 by adhesive, welding, suction, friction, static, or by other mechanical means. In another example, the guide rail 314 may be integrally formed with the case body 318. A platform of the expandable grip accessory (not illustrated) may be adjacent to an exterior surface 324 of the electronic device, or the surface 324 of FIG. 7 may be a base layer of the case body 318 intermediately disposed between the expandable grip accessory and an interior rail 342. When the expandable grip accessory is coupled to the guide rail 314, the platform of the expandable grip accessory slides beneath the flange of the interior rail 342 between docking positions adjacent to a first end 330, a second end 332, a third end 334, and a fourth end 336 of the track 336. As shown in FIG. 7, the guide rail 314 has a walled loop that is shaped like a lightning bolt, and therefore the expandable grip accessory can move within an irregular-shaped opening 336 between docking positions.

Any one of the exemplary guide rails 14, 114, 214, 314 of FIGS. 1-7 permits a user to indirectly attach an expandable grip accessory to an electronic device or case, and move the expandable grip accessory across the exterior surface of the electronic device or case. Specifically, the guide rail 14, 114, 214, 314 is configured to slidably receive a platform of the expandable grip accessory and permit the expandable grip accessory to slide between different docking positions while also permitting expandable grip accessory to collapse and expand in any docking position. The guide rail 14, 114, 214, 314 may allow a user to reposition the expandable grip accessory relative to the electronic device or case for a variety of reasons, which may include, for example, to improve grip, to change angle for a taking a photograph, to play a game, to facilitate typing, to better prop the electronic device, etc. While the guide rail 14, 114, 214, 314 may be permanently or removably attached to the electronic device or case, the expandable grip accessory is removable such that a user can remove, replace, and/or attach a different expandable grip accessory without removing the guide rail 14, 114, 214, 314 from the exterior surface of the grip accessory or case. While the illustrated guide rails 14, 114, 214, 314 are sized and shaped to receive a platform of an expandable grip accessory, in other examples, the guide rail 14, 114, 214, 314 may be sized and shaped to receive a different portion of the expandable grip accessory. In one example, the track 26, 126, 226, 326 of the guide rail 14, 114, 214, 314 may have a narrow opening 36, 136, 236, 336 to slidably couple to a smaller platform, a quick-release locking component, and/or the first end 62 of the device body 50. In another example, the device body 50 or quick-release locking component may directly or indirectly (e.g., via a quick-release locking component) clip into a groove or opening formed in the track 26, 126, 226, 326 to slide within the opening and along and around the shaped perimeter of the track 26, 126, 226, 326.

The guide rail 14, 114, 214, 314 may be shaped to provide a number of different positions for docking the expandable grip accessory while providing different designs formed by the outline of the track 26, 126, 226, 326. The guide rail 14, 114, 214, 314 may be manufactured as an integrated component, or the guide rail 14, 114, 214, 314 may have a modular design such that a user may create a unique design by attaching multiple rail pieces to form an enclosed track 26, 126, 226, 326. The guide rail 14, 114, 214, 314 may be configured to receive a platform of a different device or accessory, and the button of the expandable grip accessory may be configured to mount to a fixed dock, such as, for example, a wall mount. The rail permits the user to slide the electronic device to change position and/or angle of the electronic device or case relative to the wall mount.

The figures and description provided herein depict and describe preferred examples of a guide rail accessory for a portable electronic device or a case of a portable electronic device for purposes of illustration only. One skilled in the art will readily recognize from the foregoing discussion that alternative examples of the components illustrated herein may be employed without departing from the principles described herein. Thus, upon reading this disclosure, those of skill in the art will appreciate still additional alternative structural and functional designs for devices and cases that allow movement of the accessory. Thus, while particular examples and applications have been illustrated and described, it is to be understood that the disclosed examples are not limited to the precise construction and components disclosed herein. Various modifications, changes and variations, which will be apparent to those skilled in the art, may be made in the arrangement, operation and details of the methods and components disclosed herein without departing from the spirit and scope defined in the appended claims.

1-24. (canceled)

25. An accessory for a portable electronic device or case for an electronic device, the accessory comprising:
a walled loop defining a first end, a second end, and an opening extending between the first end and the second end, the walled loop arranged to attach to a surface of an electronic device or case;
a grip accessory adapted to be movably disposed in the opening of the walled loop between the first end and the second end of the walled loop, the grip accessory having a first end coupled to the walled loop and a second end opposite the first end;
wherein the walled loop is adapted to at least partially surround the first end of the grip accessory to retain the grip accessory.

26. The accessory of claim 25, wherein the grip accessory is movable along a lateral axis and is movable along a longitudinal axis.

27. The accessory of claim 25, further comprising a track including the walled loop and a flange extending from the walled loop.

28. The accessory of claim 27, wherein the track slidably receives the grip accessory.

29. The accessory of claim 27, wherein the flange extends around the walled loop and is adapted to limit movement of the grip accessory along the longitudinal axis.

30. The accessory of claim 25, further comprising a platform coupled at the first end of the grip accessory, the walled loop arranged to slidably receive the platform.

31. The accessory of claim 25, wherein the first end of the walled loop includes a locking member adapted to releasably lock to the grip accessory, the locking member adapted to retain the grip accessory in a position adjacent the first end when the locking member engages the grip accessory.

32. A case for a portable electronic device, the case comprising:
a case body arranged to receive a portable electronic device on a first face and includes a second face opposite the first face;
a walled loop carried by the second face of the case body, the walled loop including a first end, a second end, and an opening extending between the first end and the second end, the walled loop adapted to retain a grip accessory for movement between various positions along the opening of the walled loop.

33. The case of claim 32, further comprising:
wherein the grip accessory is adapted to be movably disposed in the opening of the walled loop between the first end and the second end of the walled loop, the grip accessory having a first end coupled to the walled loop and a second end opposite the first end, and
wherein the walled loop is adapted to at least partially surround the first end of the grip accessory to retain the grip accessory.

34. The case of claim 33, wherein the grip accessory is slidably coupled to the track and is movable in a lateral direction.

35. The case of claim 33, further comprising a platform coupled to the first end of the device body, the walled loop arranged to slidably receive the platform.

36. The case of claim 35, wherein the platform is disposed between the second face of case body and a flange of the walled loop.

37. The case of claim 36, wherein the flange extends around the walled loop and limits movement of the grip accessory along a longitudinal axis of the grip accessory.

38. The case of claim 33, wherein the first end of the walled loop includes a locking member adapted to releasably lock to the grip accessory, the locking member adapted to retain the grip accessory in a position adjacent the first end of the walled loop when the locking member engages the grip accessory.

39. The case of claim 32, wherein the walled loop is integrally formed with the second face of the case body.

40. The case of claim 32, wherein the walled loop is fixed to the second face of the case body.

41. The case of claim 32, wherein the walled loop is removably coupled to the second face of the case body.

42. The case of claim 32, further comprising a track including the walled loop and a flange protruding into the opening from the walled loop.

43. The case of claim 32, wherein the track has a linear shape.
